(19) United States
(12) Patent Application Publication
(10) Pub. No.: US 2010/0260092 A1
(43) Pub. Date: Oct. 14, 2010

(54) METHOD AND APPARATUS FOR IMPLEMENTING COOPERATIVE MIMO IN A WIRELESS LOCAL AREA NETWORK

(75) Inventor: Nagendra Nagaraja, Bangalore (IN)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/421,496

(22) Filed: Apr. 9, 2009

(51) Int. Cl. H04B 7/14

(52) U.S. Cl. 370/315

(57) ABSTRACT

A method of wireless communication for facilitating cooperative multiple in, multiple out in a wireless local area network with a primary channel and a secondary channel is disclosed. The method includes determining that a frame has been received on the secondary channel; and, relaying the frame to an intended wireless node on the secondary channel. An apparatus for performing the method is also disclosed.

### BACKGROUND

I. Field

The following description relates generally to communication systems, and more particularly, to a method and apparatus for implementing cooperative multiple input, multiple output (MIMO).

II. Background

In certain conventional radio systems, a single antenna is used at the source, and another single antenna is used at the destination. These systems are referred to as single-input single-output (SISO) radio systems. SISO radio systems often encounter problems with multipath effects. For example, when an electromagnetic field (EM field) is met with obstructions such as hills, canyons, buildings, and utility wires, the wavefronts are scattered, and thus they take many paths to reach the destination. The late arrival of scattered portions of the signal causes problems such as fading, cut-out (cliff effect), and intermittent reception (picket fencing). In digital communications systems such as wireless Internet, it can cause a reduction in data speed and an increase in the number of errors.

Multiple input, multiple output (MIMO) refers to an antenna technology for wireless communications in which multiple antennas may be used at either the source (transmitter) and/or the destination (receiver). This is as opposed to SISO radio systems, where neither the transmitter nor receiver has multiple antennas. The use of multiple antennas at each end of the communications circuit allows the minimization of errors and optimization of data speed. The use of two or more antennas, along with the transmission of multiple signals (one for each antenna) at the source and the destination, eliminates the trouble caused by multipath wave propagation, and in some instances can even take advantage of this effect. MIMO is one of several forms of smart antenna technology, the others being multiple input, single output (MISO) and single input, multiple output (SIMO).

Although implementing MIMO provides better spectral efficiency and higher bit rates, by definition the technology requires the use of multiple antennas. This additional hardware requirement and complexity will increase cost. Also, MIMO is the most effective in rich multipath environments, which is not always guaranteed.

Further, hybrid wireless communication networks that contain wireless nodes conforming to different communication standards such as either the Institute of Electrical and Electronic Engineer (IEEE) 802.11a/b/g standards, which do not support multiple antennas, or IEEE 802.11n, which supports multiple antennas, are not efficient. Specifically, in hybrid setups, throughput for MIMO devices decreases. This is because in IEEE 802.11a/b/g, the existence of multipath signals is treated as a performance degrading factor. In contrast, in IEEE 802.11n, through the use of MIMO, the existence of multipath effects is treated as a performance enhancing factor. Because it is almost impossible to achieve 802.11n-only network deployment, it will not be possible to achieve optimal performance of a hybrid network.

Consequently, it would be desirable to address one or more of the deficiencies described above.

### SUMMARY

According to various aspects, the subject innovation relates to apparatus and/or methods for facilitating deployment of wireless networks that include multiple input, multiple output (MIMO) nodes.

According to an aspect of the disclosure, a method of wireless communication in a wireless local area network with a primary channel and a secondary channel is provided. The method includes determining that a frame has been received on the secondary channel; and, relaying the frame to an intended wireless node on the secondary channel.

According to yet another aspect of the disclosure, an apparatus for wireless communication in a wireless local area network with a primary channel and a secondary channel is provided. The apparatus includes means for determining that a frame has been received on the secondary channel; and, means for relaying the frame to an intended wireless node on the secondary channel.

According to yet another aspect of the disclosure, an apparatus for wireless communication in a wireless local area network with a primary channel and a secondary channel is provided. The apparatus includes a receiver for determining that a frame has been received on the secondary channel; and, a transmitter for relaying the frame to an intended wireless node on the secondary channel.

According to yet another aspect of the disclosure, an apparatus for wireless communication in a wireless local area network with a primary channel and a secondary channel is provided. The apparatus includes a memory storing frames received on the secondary channel; and a processing system configured to determine that a frame has been received on the secondary channel; and, relay the frame to an intended wireless node on the secondary channel.

According to yet another aspect of the disclosure, a computer-program product for facilitating wireless communication in a wireless local area network with a primary channel and a secondary channel is disclosed. The computer-program product includes a machine-readable medium encoded with instructions executable by a processor to determine that a frame has been received on the secondary channel; and relay the frame to an intended wireless node on the secondary channel.

According to yet another aspect of the disclosure, an apparatus is disclosed. The apparatus includes a transceiver for wireless communication in a wireless local area network with a primary channel and a secondary channel; and, a processing system. The processing system is configured to determine that a frame has been received on the secondary channel; and, relay the frame to an intended wireless node on the secondary channel.

According to yet another aspect of the disclosure, a method of wireless communication in a wireless local area network with a primary channel and a secondary channel is provided. The method includes receiving a transmission of a first frame on the primary channel from a first wireless node; determining that a second frame has been received on the secondary channel from a second wireless node that is relayed from the first wireless node; and, processing the first frame and the second frame to achieve a MIMO transmission.

According to yet another aspect of the disclosure, an apparatus for wireless communication in a wireless local area network with a primary channel and a secondary channel is provided. The apparatus includes means for receiving a transmission of a first frame on the primary channel from a first wireless node; means for determining that a second frame has been received on the secondary channel from a second wireless node that is relayed from the first wireless node; and means for processing the first frame and the second frame to achieve a MIMO transmission.

According to yet another aspect of the disclosure, an apparatus for wireless communication in a wireless local area network with a primary channel and a secondary channel is provided. The apparatus includes a receiver for receiving a transmission of a first frame on the primary channel from a first wireless node; and a processor configured to determine that a second frame has been received on the secondary channel from a second wireless node that is relayed from the first wireless node; and process the first frame and the second frame to achieve a MIMO transmission.

According to yet another aspect of the disclosure, an apparatus for wireless communication in a wireless local area network with a primary channel and a secondary channel is provided. The apparatus includes a memory storing a transmission of a first frame on the primary channel from a first wireless node; and, a processing system configured to determine that a second frame has been received on the secondary channel from a second wireless node that is relayed from the first wireless node; and process the first frame and the second frame to achieve a MIMO transmission.

According to yet another aspect of the disclosure, a computer-program product for facilitating wireless communication in a wireless local area network with a primary channel and a secondary channel is provided. The machine-readable medium is encoded with instructions executable by a processor to cause the processor to receive a transmission of a first frame on the primary channel from a first wireless node; determine that a second frame has been received on the secondary channel from a second wireless node that is relayed from the first wireless node; and, relay the first frame and the second frame to achieve a MIMO transmission.

According to yet another aspect of the disclosure, an apparatus is provided. The apparatus includes a transceiver for wireless communication in a wireless local area network with a primary channel and a secondary channel; and a processing system. The processing system is configured to receive a transmission of a first frame on the primary channel from a first wireless node; determine that a second frame has been received on the secondary channel from a second wireless node that is relayed from the first wireless node; and, relay the first frame and the second frame to achieve a MIMO transmission.

Although particular aspects are described herein, many variations and permutations of these aspects fall within the scope of the disclosure. Whereas some benefits and advantages of the preferred aspects are mentioned, the scope of the disclosure is not intended to be limited to particular benefits, uses, or objectives. Rather, aspects of the disclosure are intended to be broadly applicable to different wireless and wire line technologies, system configurations, networks, and transmission protocols, some of which are illustrated by way of example in the figures and in the following Detailed Description. The detailed description and drawings are merely illustrative of the disclosure rather than limiting, the scope of the disclosure being defined by the appended claims and equivalents thereof.

### BRIEF DESCRIPTION OF THE DRAWINGS

These and other sample aspects of the disclosure will be described in the detailed description that follow, and in the accompanying drawings, wherein:

FIG. 1 is a diagram of a wireless network configured in accordance with one aspect of the disclosure;

FIG. 2 is a diagram of a frame structure of a legacy frame format that may be used in a wireless communication apparatus in the wireless network of FIG. 1;

FIG. 3 is a diagram of another frame structure of a new frame format that may be used in a wireless communication apparatus in the wireless network of FIG. 1;

FIG. 4 is a diagram of yet another frame structure of a mixed frame format that may be used in a wireless communication apparatus in the wireless network of FIG. 1;

FIG. 5 is a block diagram of a wireless communication apparatus as configured in accordance with an aspect of the disclosure that may be used in the wireless network of FIG. 1;

FIG. 6 is a flow chart of a mode of operation of a wireless communication apparatus in the wireless network of FIG. 1 configured in accordance with an aspect of the disclosure;

FIG. 7 is a flow chart of a mode of operation of an access point in the wireless network of FIG. 1 configured in accordance with an aspect of the disclosure;

FIG. 8 is a block diagram illustrating an example of a hardware configuration for a processing system in a wireless node in the wireless communications network of FIG. 1;

FIG. 9 is a block diagram illustrating an apparatus for facilitating implementation of a cooperative MIMO system for a wireless communication device; and

FIG. 10 is a block diagram illustrating an apparatus for facilitating implementation of a cooperative MIMO system for an access point.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An aspect of the disclosure contained herein facilitates deployment of an efficient wireless network in which devices supporting MIMO to various degrees form a cooperative network setup, referred to as a co-operative MIMO system. The co-operative MIMO system provides transmit diversity, in a similar fashion as a non-hybrid MIMO wireless system. However, the co-operative MIMO system is designed to be more effective than a non-hybrid MIMO system because diversity is almost guaranteed.

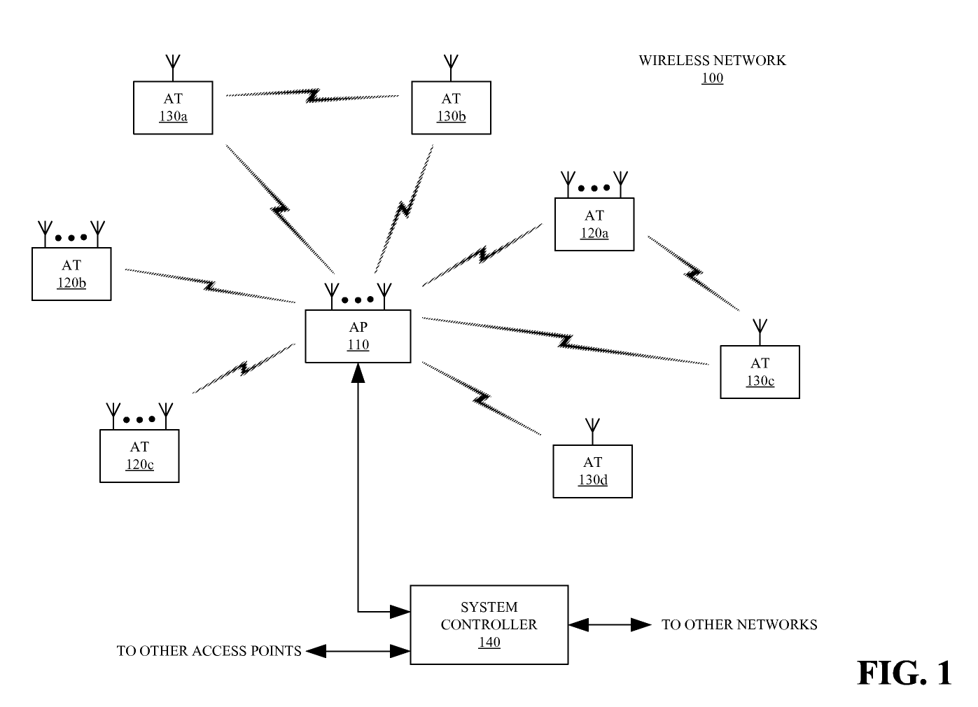

Several aspects of a wireless network 100 that includes devices that implements a co-operative MIMO system will now be presented with reference to FIG. 1. The wireless network 100 is shown with several wireless nodes, generally designated as an access point 110, and a plurality of access terminals 120a-120c and 130a-130d. Each wireless node is capable of receiving and/or transmitting signals using radio frequency, with the access point 110 and the plurality of access terminals 120a-120c implementing some variation of MIMO technology while the plurality of access terminals 130a-130d implements only SISO technology. In the detailed description that follows, for downlink communications the term “access point” is used to designate a transmitting node and the term “access terminal” is used to designate a receiving node, whereas for uplink communications these terms are conversely used to refer to a receiving node and a transmitting node, respectively. However, those skilled in the art will readily understand that other terminology or nomenclature may be used for a base station and/or mobile station. By way of example, an access point may be referred to as a base station, a base transceiver station, a station, a terminal, a node, an access terminal acting as an access point, or some other suitable terminology. An access terminal may be referred to as a mobile station, a user equipment, a user terminal, a subscriber station, a station, a wireless device, an access point acting as an access terminal, a terminal, a node, or some other suitable terminology. The various concepts described throughout this disclosure are intended to apply to all suitable wireless nodes regardless of their specific nomenclature.

The wireless network 100 may support any number of access points distributed throughout a particular area to provide coverage for the plurality of access terminals 120a-120c and 130a-130d. A system controller 140 may be used to provide coordination and control of the access points, as well as access to other networks (e.g., Internet) for the access terminals 120a-120c and 130a-130d. For simplicity, one access point 110 is shown. An access point is generally a fixed terminal that provides network access to access terminals in the area of coverage. However, the access point may be mobile in some applications. An access terminal, which may be fixed or mobile, utilizes the network connectivity of an access point or engages in peer-to-peer communications with other access terminal. Examples of devices that may operate as an access terminal include telephones (e.g., cellular telephones), laptop computers, desktop computers, Personal Digital Assistants (PDAs), digital audio players (e.g., MP3 players), cameras, game consoles, or any other suitable devices having wireless communication capabilities.

A wireless node, whether an access terminal or access point, may be implemented with a protocol that utilizes a layered structure that includes a physical (PHY) layer that implements all the physical and electrical specifications to interface the wireless node to the shared wireless channel, a MAC layer that coordinates access to the shared wireless channel, and an application layer that performs various data processing functions including, by way of example, speech and multimedia codecs and graphics processing. Additional protocol layers (e.g., network layer, transport layer) may be required for any particular application. In some configurations, the wireless node may act as a relay point between a base station and mobile station, or two mobile stations, and therefore, may not require an application layer. Those skilled in the art will be readily able to implement the appropriate protocol for any wireless node depending on the particular application and the overall design constraints imposed on the overall system.

In an aspect of the disclosure, the wireless network 100 that implements a wireless network that conforms to the IEEE 802.11n standard. In IEEE 802.11n, which implements a Wireless Local Area Network (WLAN) using Orthogonal Frequency Division Multiplexing (OFDM) system that is an improved version of the IEEE 802.11a/g standard, the physical layer operates in one of three (3) modes in the time domain: Legacy Mode, Mixed (Hybrid) Mode and Green Field Mode. Two new frame formats are defined for the Physical Layer Convergence Protocol (PLCP): a Mixed Mode frame format and a Green Field frame format. These two frame formats are also referred to together as High Throughput (HT) formats and support a 40 MHz channel that is made up of two (2) 20 MHz sub-channels. In addition to the HT formats, there is a legacy format that duplicates the 20 MHz legacy packet that supports two 20 MHz halves of a 40 MHz channel.

Legacy networks had only supported transmission over a single 20 MHz channel. In IEEE 802.11n, data could be transmitted over a single 20 MHz channel or two 20 MHz channels that are bonded to create a 40 MHz channel. In another mode, duplicate transmissions may also be sent over the two 20 MHz channels. In the legacy and HT modes supporting 20 MHz transmissions, each transmission occurs over a single 20 MHz channel, referred to as a primary channel. In the 40 MHz HT mode of transmission, two adjacent 20 MHz channels are used. In this mode, a second channel referred to as a secondary channel is used in addition to the primary channel. In the case of the legacy duplicate mode over 40 MHz, the same data are transmitted over two adjacent 20 MHz channels.

In the example provided herein, the wireless network 100 contains both IEEE 802.11n and IEEE 802.11a/g devices, and utilizes the hybrid mode frame structure that supports these devices.

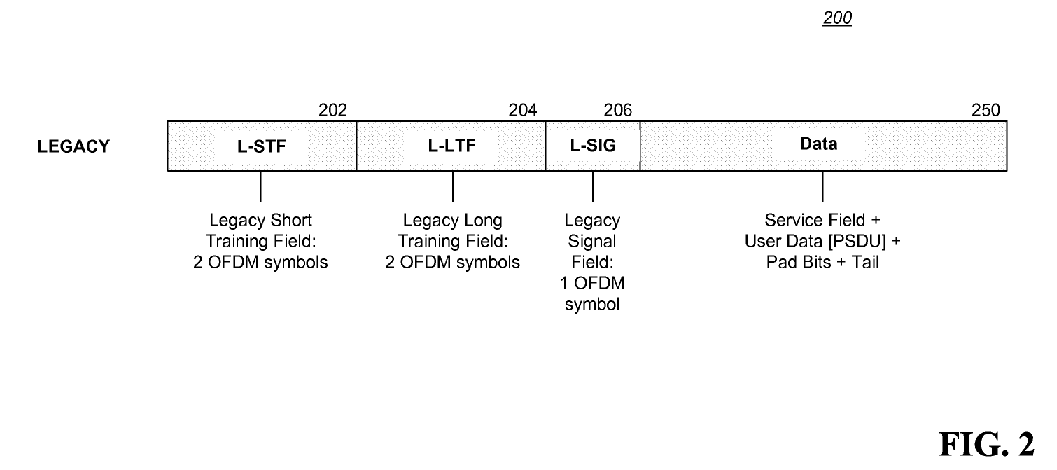

In the Legacy mode, frames are transmitted in the legacy 802.11a/g OFDM frame format. FIG. 2 illustrates a Legacy Mode frame structure 200 suitable for use in IEEE 802.11n WLAN networks. The Legacy Mode frame structure 200 contains a Legacy Short Training Field (L-STF) 202 that contains a legacy short training OFDM symbol that is identical to the IEEE 802.11a short training OFDM symbol; a Legacy Long Training Field (L-LTF) 204 that contains a legacy long training OFDM symbol that is identical to the 802.11a long training OFDM symbol; a Legacy Signal Field (L-SIG) 206 is used to transfer rate and length information. The L-SIG 206 consists of one OFDM symbol assigned to all subcarriers supported by the wireless network; and a data field 250 that includes data and checksum information.

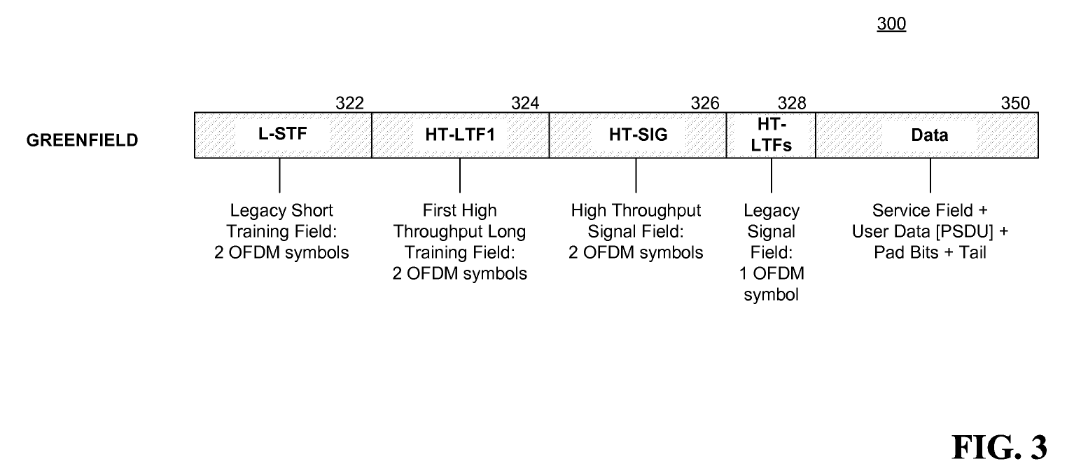

FIG. 3 illustrates a Green Field Mode frame structure 300 suitable for use in IEEE 802.11n WLAN networks. As the Green Field Mode frame structure 300 is exclusively used when a wireless node operates in the Green Field mode, all high throughput packets may be transmitted without a legacy-compatible portion. The Green Field Mode frame structure 300 includes a First HT-LTF field 302 that is a high throughput long training field that contains two instances of a training sequence; a High Throughput Signal Field (HT-SIG) field 304 that is used to carry information required to interpret the HT packet formats; a High Throughput Long Training Field (HT-LTF) that is used for the receiver to estimate the channel between each spatial mapping input (or spatial stream transmitter if no STBC is applied) and receive chain; the number of training symbols is equal or greater than the number of space-time streams; and a data field 350 similar to data field 250.

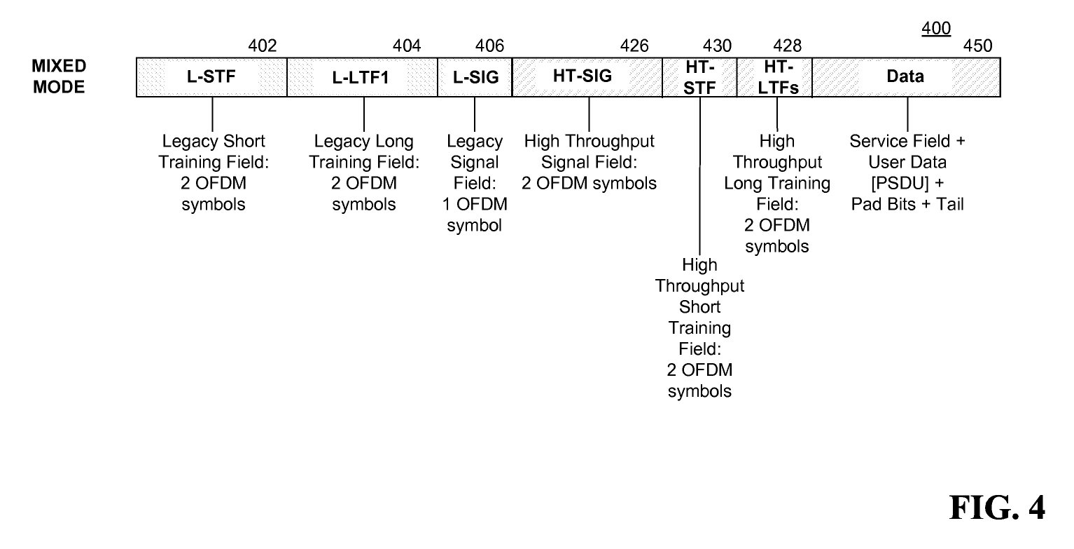

FIG. 4 illustrates a Mixed Mode frame structure 400 for use in IEEE 802.11n WLAN networks to support Mixed Mode, MIMO operation. In Mixed Mode operation, packets are transmitted with a preamble compatible with the legacy IEEE 802.11a/g standard. The L-STF 202, the L-LTF 204, and the L-SIG 206 are transmitted so they can be decoded by legacy 802.11a/g devices. The rest of the packet has fields used in the new MIMO training sequence format, including a High Throughput Short Training Field (HT-STF) 430 that is used to improve AGC (Automatic Gain Control) training in a multi-transmit and multi-receive system.

To support Hybrid Mode transmission, where there needs to be a coexistence of devices conforming to the different IEEE 802.11n/a/g standards, any possible degradation of performance of the Hybrid Mode as compared to the Greenfield Mode needs to be managed. In Hybrid Mode operation, IEEE 802.11n protocol can be embedded in IEEE 802.11a/g transmissions and consequently all devices can still communicate using the IEEE 802.11a/g protocol. Thus, IEEE 802.11n devices may still implement IEEE 802.11n features such as the channel bonding feature of the IEEE 802.11n standard, where two non-overlapping channels totaling 40 MHz of bandwidth can be combined for MIMO transmissions.

In an aspect of the disclosure, IEEE 802.11a/g devices that normally cannot effect MIMO transmissions may still achieve similar results as that provided by MIMO systems by transmitting data directly to the access point using one 20 MHz channel and using a “cooperating device” to relay data to the access point in another 20 MHz channel. Specifically, data is transmitted to the access point directly in one band and, in another band, cooperative information is sent to the access point supporting the IEEE 802.11n standards by neighboring nodes that are configured to relay the transmissions. By approaching transmission in this fashion, the MAC data rate remains the same. However, the PHY data rate may be doubled and overall throughput will be increased due to diversity gain.

Two modes of operation, referred to as “cooperative MIMO” and “virtual MIMO” modes of operations, may be implemented by embedding IEEE 802.11n information in IEEE 802.11a/g packets. Using the cooperative and virtual MIMO modes of operation, IEEE 802.11a/g devices can achieve better performance compared to normal IEEE 802.11a/g transmissions even through the use of only a single antenna, and a wideband channel with a total bandwidth of 40 MHz (two separate, non-overlapping bands of 20 MHz) can be created. Further, the throughput of the Hybrid mode improves.

In an aspect of the disclosure, in the cooperative MIMO mode of operation, cooperative information is information that a wireless node intends to transmit to the access point, but instead of directly transmitting the information to the access point, the wireless node sends it to another wireless node. The other wireless node will then relay this information to the access point.

In the virtual MIMO mode of operation, similar to real MIMO, the same data is transmitted across two bands using the single antenna of an IEEE 802.11a/g device. One band is directly received by the access point and another band is used to relay information from another device. Through the use of the random access nature of the operation of the network, because only one device transmits, other devices can act like relays for forwarding the transmission. So because of “channel bonding”, relaying and direct transmission are achieved through separate 20 MHz transmission channels.

Under normal hybrid setup, overall system capacity decreases because of incompatibility between IEEE 802.11n/a/g and IEEE 802.11a/g devices. Most of the 40 MHz bandwidth is wasted, because IEEE 802.11a/g devices are single antenna devices. In an aspect of the disclosure, full bandwidth and other node power is used to provide diversity. Since the access point is assumed to be an IEEE 802.11n device, which is more effective when there is spatial diversity, this approach also ensures that full use of access point capability is achieved. Since 5 GHz frequency band contains 8 non-overlapping channels, any chunk at any granularity from 5 MHz to 20 MHz may be used as required.

The IEEE 802.11 standard makes it mandatory that all stations implement a distributed coordination function (DCF), a form of carrier sense multiple access with collision avoidance (CSMA/CA). CSMA is a contention-based protocol that attempts to ensure all wireless nodes first sense the medium before transmitting. The main goal is to avoid having wireless nodes transmit at the same time, which will result in collisions and require retransmissions.

If a wireless node that wants to send a frame senses energy above a specific threshold on the medium (which could mean the transmission of another wireless node), the wireless node wanting access will wait until the medium is idle before transmitting the frame. The collision avoidance aspect of the protocol pertains to the use of acknowledgements that a receiving wireless node sends to the sending wireless node to verify error-free reception.

The DCF protocol is somewhat more complex than this, though. For example, an 802.11 wireless node utilizes information it gains from other frames that wireless nodes are sending over the wireless network. In the control field of each frame, there is a duration field that a sending wireless node places a value in, to indicate how long the wireless node will require the medium. As part of making a decision on whether to transmit a frame, a wireless node must see that the time associated with the duration value of the last frame sent has expired, as well as sense that no physical transmission is taking place. The duration field enables wireless nodes to reserve the medium for subsequent frames of some specific 802.11-defined frame exchanges (e.g., RTS/CTS).

Because of its nature, DCF supports the transmission of asynchronous signals. A distinguishing factor of asynchronous signaling is that there are no timing requirements between data carrying frames. For example, the DCF protocol doesn't make any attempt to deliver a series of data frames within any timeframe or at any instant in time. As a result, there is a random amount of delay between each data frame transmission. This form of synchronization is effective for network applications, such as e-mail, Web browsing and VPN access to corporate applications.

As an optional access method, the IEEE 802.11a/g standard defines a point coordination function (PCF), which enables the transmission of time-sensitive information. With PCF, a point coordinator within the access point controls which wireless nodes can transmit during any give period of time. Within a time period called the contention free period, the point coordinator will step through all wireless nodes operating in PCF mode and poll them one at a time. For example, the point coordinator may first poll wireless node A, and during a specific period of time wireless node A can transmit data frames (and no other wireless node can send anything). The point coordinator will then poll the next wireless node and continue down the polling list, while letting each wireless node to have a chance to send data.

Thus, PCF is a contention-free protocol and enables wireless nodes to transmit data frames synchronously, with regular time delays between data frame transmissions. This makes it possible to more effectively support information flows, such as video and control mechanisms, having stiffer synchronization requirements.

Timing mechanisms within the 802.11 protocol ensure that wireless nodes on the WLAN alternate between the use of DCF and PCF. As a result, the WLAN can support both asynchronous and synchronous information flows. For a period of time, wireless nodes will fend for themselves by using CSMA. For the following time period, the wireless nodes will wait for a poll from the point coordinator before sending data frames. The setup shown is for a PCF topology, same can be extended to DCF as well.

Further IEEE 802.11e enhances the DCF and the PCF mode of operation, through a new coordination function: the Hybrid Coordination Function (HCF). Within the HCF, there are two methods of channel access, similar to those defined in the legacy 802.11 MAC: HCF Controlled Channel Access (HCCA) and Enhanced Distributed Channel Access (EDCA). Both EDCA and HCCA define Traffic Categories (TC). For example, emails could be assigned to a low priority class, and Voice over Wireless LAN (VOWLAN) could be assigned to a high priority class. With EDCA, high priority traffic has a higher chance of being sent than low priority traffic: a station with high priority traffic waits a little less before it sends its packet, on average, than a station with low priority traffic. The HCCA functions in a similar fashion to the PCF. However, in contrast to PCF, in which the interval between two beacon frames is divided into two periods of Contention Free Period (CFP) and the Contention Period (CP), the HCCA allows for CFPs being initiated at almost any time during a CP.

In an aspect of the disclosure, when an access point decodes frames from each node, it knows which information belongs to which nodes as only one node transmits in a given channel during each time interval. Using this information the access point can combine information received at various time slots from the particular node. The combination of information from different nodes provides diversity. This implements, virtually, the MIMO principle, without requiring the use of extra antennas at each of the nodes.

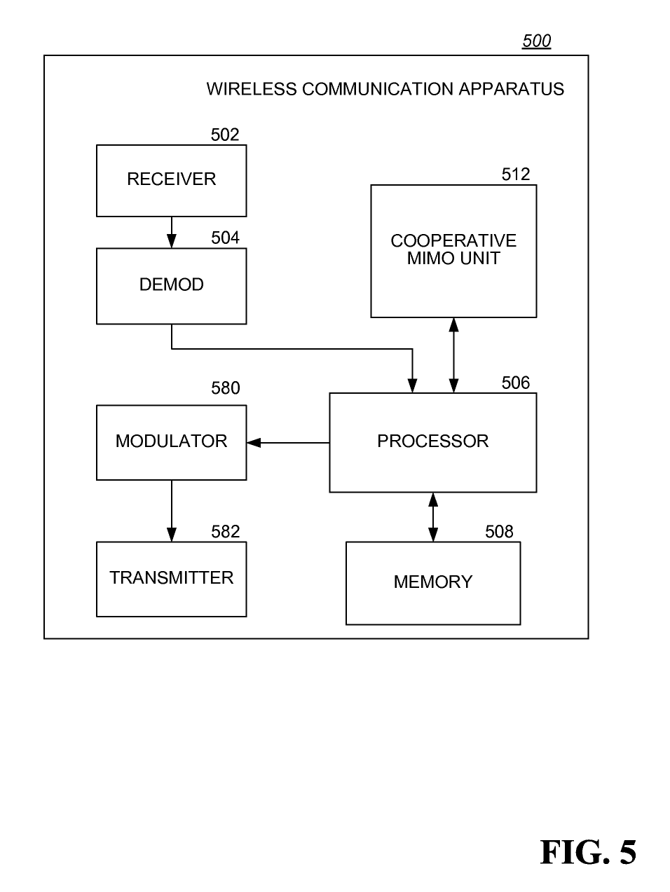

FIG. 5 is an illustration of a wireless communication apparatus 500 that facilitates receiving and processing messages received over a wireless network such as the wireless network 100 of FIG. 1. The wireless communication apparatus 500 includes a receiver 502 that receives a signal from, for instance, a receive antenna (not shown), performs typical actions on (e.g., filters, amplifies, downconverts, etc.) the received signal, and digitizes the conditioned signal to obtain samples. Receiver 502 then passes the samples to a demodulator 504 that can demodulate received symbols and provide them to a processor 506 for data processing. The processor 506 can be a processor dedicated to analyzing information received by the receiver 502 and/or generating information for transmission by a transmitter 582, a processor that controls one or more components of the wireless communication apparatus 500, and/or a processor that both analyzes information received by the receiver 502, generates information for transmission by the transmitter 582, and controls one or more components of the wireless communication apparatus 500.

The wireless communication apparatus 500 can further comprise a cooperative MIMO unit 512 coupled to the processor 506 that allows the wireless communication apparatus 500 to operate in a cooperative MIMO system. The wireless communication apparatus 500 still further comprises a modulator 580 and transmitter 582 that respectively modulate and transmit signals to, for instance, another wireless communication apparatus (access terminals, access points, etc.). This can operate as part of a disparate bidirectional wireless network utilized to communicate information. Although depicted as being separate from the processor 506, it is to be appreciated that the cooperative MIMO unit 512, demodulator 504, and/or modulator 580 can be part of the processor 506 or multiple processors (not shown).

The wireless communication apparatus 500 can additionally comprise a memory 508 that is operatively coupled to the processor 506 and that can store data to be transmitted, received data, information related to available channels, data associated with analyzed signal and/or interference strength, information related to an assigned channel, power, rate, or the like, and any other suitable information for estimating a channel and communicating via the channel. The memory 508 can additionally store protocols and/or algorithms associated with estimating and/or utilizing a channel (e.g., performance based, capacity based, etc.) as well as operating in a cooperative MIMO system.

It will be appreciated that the data store (e.g., the memory 508) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 508 of the subject apparatus and methods is intended to comprise, without being limited to, these and any other suitable types of memory.

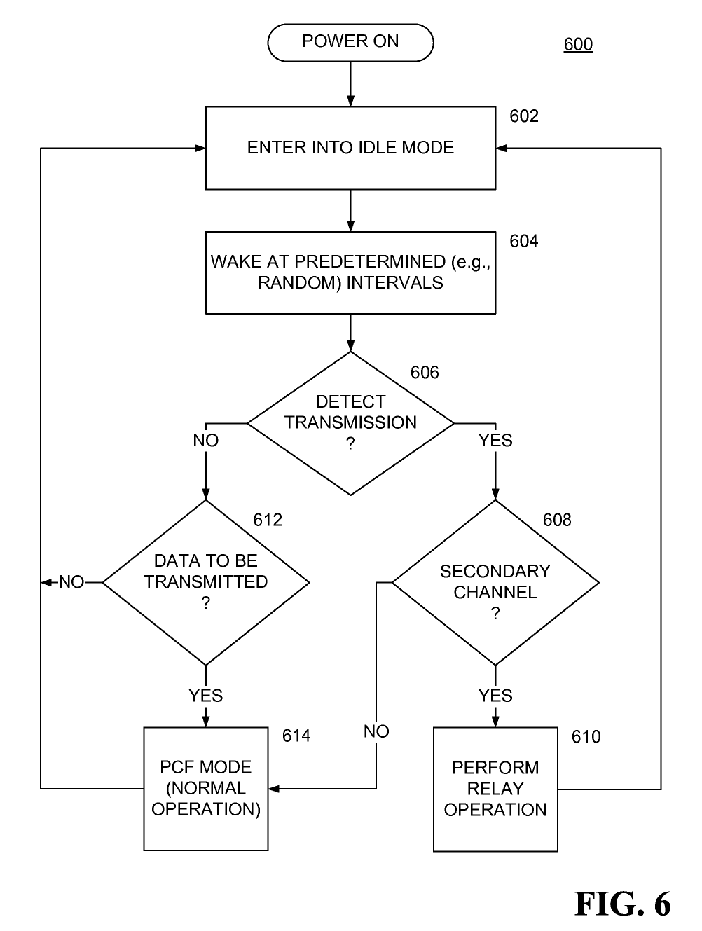

FIG. 6 illustrates a Hybrid mode coordination function process 600 that may be implemented by the cooperative MIMO unit of 512 of FIG. 5, where an example of the various aspects of the disclosure is applied to an IEEE 802.11a/g device. In step 602, the wireless node enters into an idle mode. Then, in step 604, the wireless node will wake at a predetermined interval to perform operations such as transmit or receive data. Once the wireless node awakes, operation continues with step 606, where a detection of transmission by the wireless node is performed. In an aspect of the detection, the wireless node will determine if there is a transmission from another wireless node directed to it. If a transmission is detected, operation of the wireless node continues with step 608, where it is determined whether the detected transmission is occurring over the secondary channel. If so, then the process continues with step 610, where a relay operation is performed by the wireless node. Otherwise, if it is determined that the transmission occurs over the primary mode, then operation continues with step 614,

In step 610, if a frame is received on secondary channel in Hybrid Mode as determined by step 608, the wireless node will operate to relay the information by retransmitting the information to the access point. In an aspect of the disclosure, the relay operation performed by the wireless node in step 610 is an amplify and forward operation. The wireless node will receive the packet and perform a forwarding of the packet without decoding the MAC portion of the transmission. In another aspect of the disclosure, the wireless node can decode the packet and perform other processing on the packet, such as error detection, before retransmitting it to the access point. In either case, no special frame structure is required. Once the relay operation is completed in step 610, the wireless node will return to step 602, where it will reenter the idle mode.

In step 614, if it has previously been determined in step 608 that the detected transmission is occurring over the primary mode, then the wireless node will receive the information over the primary channel in the IEEE 802.11a/g manner. In an aspect, the wireless node will operate in the PCF mode to complete transmission of the information, and then operation will return to step 602.

Returning to step 606, where the wireless node has not detected a transmission, operation will continue to step 612, where the wireless node will determine if it has data to transmit or other operations that it needs to perform while it is awake. If so, operation will continue with step 614, where the wireless node will transmit the data as previously explained. If not, then operation will return to step 602, where the wireless node will again enter in the idle mode.

In an aspect of the disclosure, with reference to the wireless network 100 of FIG. 1, the wireless nodes 130b/130c are the wireless nodes that originally transmit the information, and the wireless nodes 120a/130a are the cooperative MIMO wireless nodes that are relaying the data transmissions.

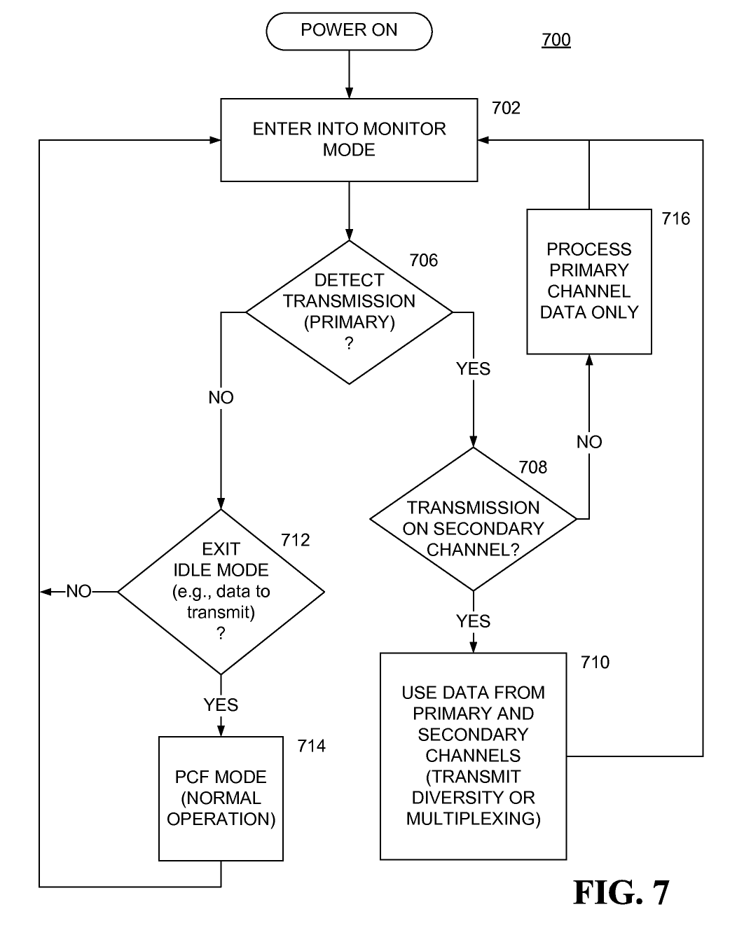

FIG. 7 illustrates a Hybrid Co-ordination Function with Co-operative MIMO (HCF-COMIMO) process 600 that may be implemented by the cooperative MIMO unit of 512 of the wireless communication apparatus 500 FIG. 5, where an example of the various aspects of the disclosure is applied to a wireless node being an access point that is capable of interoperating with IEEE 802.11n and IEEE 802.11a/g devices. In step 602, the wireless node enters into an idle mode. Then, in step 606, a detection of any transmissions on the wireless network by the wireless node is performed. In an aspect of the detection, the wireless node will determine if there is a transmission from another wireless node directed to it. If a transmission is detected, operation of the wireless node continues with step 608, where the wireless node also determines if there is a transmission that is occurring over the secondary channel. In an aspect, the wireless node will determine if there is a transmission over the secondary channel within a coherence time. If so, then the process continues with step 610, where MIMO reception is performed by the wireless node. Otherwise, if it is determined that the transmission is occurring only over the primary channel, then operation continues with step 616,

In step 610, if a frame is received on secondary channel during a coherence time as determined by step 608, the wireless node will process the data transmissions received on the primary and the secondary channels. In an aspect of the disclosure, the processing performed by the wireless node is based on whether the received data is for transmit diversity or multiplexing. In the former case, the transmit diversity will allow for most robust transmissions. In the latter case, the multiplexing will allow for higher overall throughput. Once the processing is completed in step 610, the wireless node will return to step 602, where it will reenter the idle mode.

In step 616, where the wireless node has not detected a MIMO transmission, as determined by the absence of detection of a secondary channel transmission within the coherence time in step 608, the wireless node will perform processing of the data received over the primary channel only. After the transmission has been received, operation returns to step 602.

Returning to step 606, operation will continue with step 612, where the wireless node will determine if it has data to transmit to other wireless nodes. If so, operation will continue with step 614, where the wireless node will transmit the data as described below. If not, then operation will return to step 602, where the wireless node will again enter the idle mode.

In step 614, if it has previously been determined in step 612 that the wireless node has information to transmit, then the wireless node operates to transmit information to other devices. In an aspect, the wireless node will operate in the PCF mode to complete transmission of the information, and then operation will return to step 602.

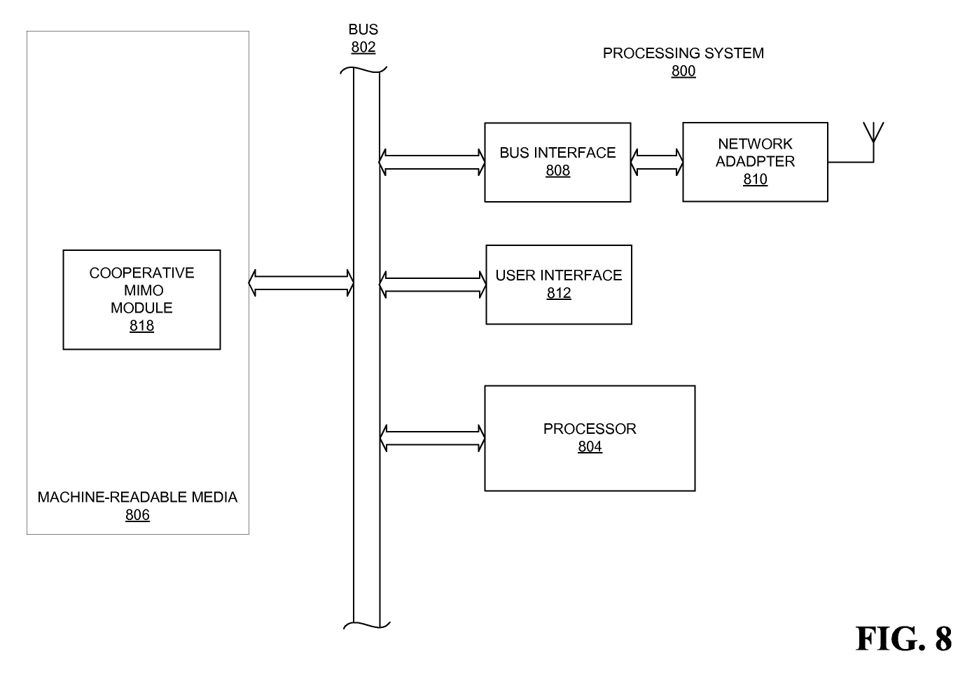

FIG. 8 is a conceptual diagram illustrating an example of a hardware configuration for a processing system 800 in a wireless node. In this example, the processing system 800 may be implemented with a bus architecture represented generally by bus 802. The bus 802 may include any number of interconnecting buses and bridges depending on the specific application of the processing system 800 and the overall design constraints. The bus links together various circuits including a processor 804, machine-readable media 806, and a bus interface 808. The bus interface 808 may be used to connect a network adapter 810, among other things, to the processing system 800 via the bus 802. The network interface 810 may be used to implement the signal processing functions of the PHY layer. In the case of an mobile wireless node 110 (see FIG. 1), a user interface 812 (e.g., keypad, display, mouse, joystick, etc.) may also be connected to the bus. The bus 802 includes a clock line (CLK) to communicate a clock. The bus 802 may also link various other circuits such as timing sources, peripherals, voltage regulators, power management circuits, and the like, which are well known in the art, and therefore, will not be described any further.

The processor 804 is responsible for managing the bus and general processing, including the execution of software stored on the machine-readable media 808. The processor 808 may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable may be embodied in a computer-program product. The computer-program product may comprise packaging materials.

In the hardware implementation illustrated in FIG. 8, the machine-readable media 806 is shown as part of the processing system 800 separate from the processor 804. However, as those skilled in the art will readily appreciate, the machine-readable media 806, or any portion thereof, may be external to the processing system 800. By way of example, the machine-readable media 806 may include a transmission line, a carrier wave modulated by data, and/or a computer product separate from the wireless node, all which may be accessed by the processor 804 through the bus interface 808. Alternatively, or in addition to, the machine readable media 804, or any portion thereof, may be integrated into the processor 804, such as the case may be with cache and/or general register files.

The processing system 800 may be configured as a general-purpose processing system with one or more microprocessors providing the processor functionality and external memory providing at least a portion of the machine-readable media 806, all linked together with other supporting circuitry through an external bus architecture. Alternatively, the processing system 800 may be implemented with an ASIC (Application Specific Integrated Circuit) with the processor 804, the bus interface 808, the user interface 812 in the case of an mobile wireless node), supporting circuitry (not shown), and at least a portion of the machine-readable media 806 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system 800 depending on the particular application and the overall design constraints imposed on the overall system.

The machine-readable media 806 is shown with a number of software modules. The software modules include instructions that when executed by the processor 804 cause the processing system 800 to perform various functions. Each software module may reside in a single storage device or distributed across multiple storage devices. By way of example, a software module may be loaded into RAM from a hard drive when a triggering event occurs. During execution of the software module, the processor 804 may load some of the instructions into cache to increase access speed. One or more cache lines may then be loaded into a general register file for execution by the processor 804. When referring to the functionality of a software module below, it will be understood that such functionality is implemented by the processor 804 when executing instructions from that software module. In one aspect, a module 818 for facilitating a cooperative MIMO system is provided.

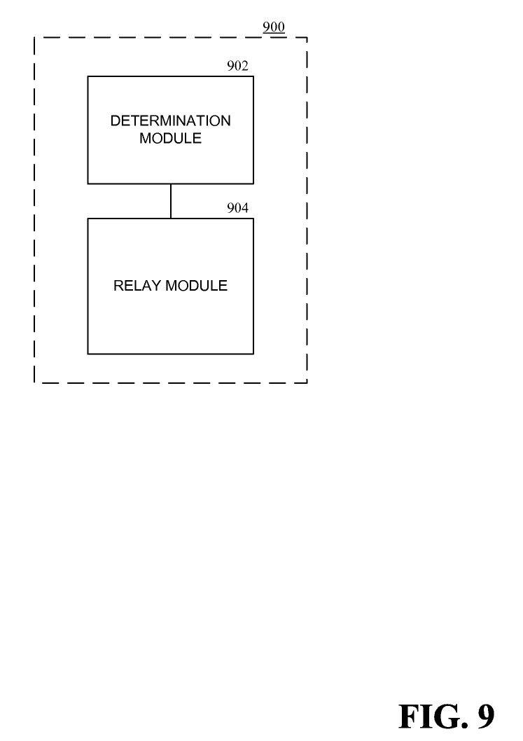

FIG. 9 is a block diagram illustrating an exemplary apparatus 900 for a wireless communication device having various modules operable to facilitate the implementation of a cooperative MIMO system in a wireless local area network having a first channel and a second channel. A determination module 902 is configure to determine that a frame has been received on the secondary channel. A relay module 904 is configured to relay the packet to an intended wireless node on the secondary channel.

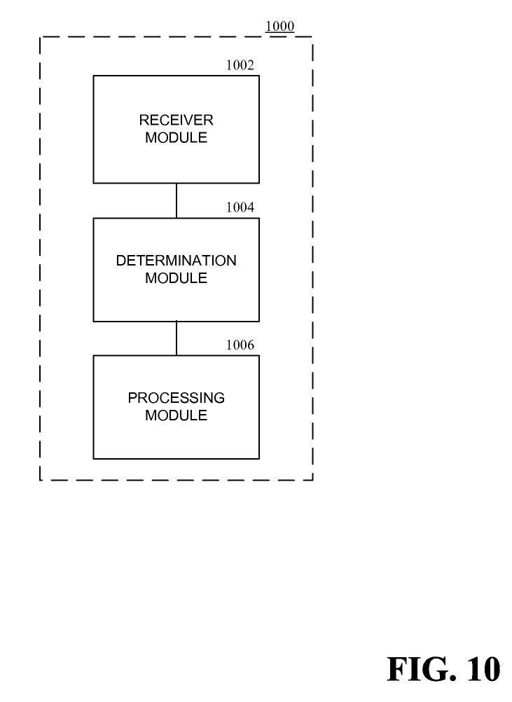

FIG. 10 is a block diagram illustrating an exemplary apparatus 1000 for an access point having various modules operable to facilitate the implementation of a cooperative MIMO system in a wireless local area network having a first channel and a second channel. A receiver module 1002 is configure to receive a transmission of a first frame on the primary channel from a first wireless node. A determination module 1004 is configured to determine that a second frame has been received on the secondary channel from a second wireless node that is relayed from the first wireless node. A processing module 1006 is configured to process the first frame and the second frame to achieve a MIMO transmission

Through the use of existing 802.11n hybrid mode, an 802.11a/g device may gain performance of benefits offered by a MIMO system and overall network throughput increased in hybrid mode. These and other results are achieved without needing to add additional antennas to the 802.11a/g devices. For example, legacy devices or other devices such as Internet tablets, cell phones and smart phones—in which adding an extra antenna will be costlier, because of lower available resources and smaller footprint of devices. With this invention of using 2 channels in 5 GHz range, one for co-operative information among the devices and other for transmission actual performance gain can be achieved. Sometimes, this performance gain can be better than actual MIMO with multiple antennas. Relay can use “amplify and forward” technique for lesser delay or latency. (other technique being decode and forward, which may not be viable for shorter range and random access)

Various aspects described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media may include, but are not limited to, magnetic storage devices, optical disks, digital versatile disk, smart cards, and flash memory devices.

The disclosure is not intended to be limited to the preferred aspects. Furthermore, those skilled in the art should recognize that the method and apparatus aspects described herein may be implemented in a variety of ways, including implementations in hardware, software, firmware, or various combinations thereof Examples of such hardware may include ASICs, Field Programmable Gate Arrays, general-purpose processors, DSPs, and/or other circuitry. Software and/or firmware implementations of the disclosure may be implemented via any combination of programming languages, including Java, C, C++, Matlab™, Verilog, VHDL, and/or processor specific machine and assembly languages.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an mobile wireless node, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The method and system aspects described herein merely illustrate particular aspects of the disclosure. It should be appreciated that those skilled in the art will be able to devise various arrangements, which, although not explicitly described or shown herein, embody the principles of the disclosure and are included within its scope. Furthermore, all examples and conditional language recited herein are intended to be only for pedagogical purposes to aid the reader in understanding the principles of the disclosure. This disclosure and its associated references are to be construed as being without limitation to such specifically recited examples and conditions. Moreover, all statements herein reciting principles, aspects, and aspects of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the disclosure. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

It is understood that any specific order or hierarchy of steps described in the context of a software module is being presented to provide an examples of a wireless node. Based upon design preferences, it is understood that the specific order or hierarchy of steps may be rearranged while remaining within the scope of the disclosure.

Although various aspects of the disclosure have been described as software implementations, those skilled in the art will readily appreciate that the various software modules presented throughout this disclosure may be implemented in hardware, or any combination of software and hardware. Whether these aspects are implemented in hardware or software depends upon the particular application and design constraints imposed on the overall system. Skilled artisans may implement the described functionality in varying ways for each particular application, but such implementation decisions should not be interpreted as causing a departure from the scope of the disclosure.

The previous description is provided to enable any person skilled in the art to understand fully the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a wireless local area network with a primary channel and a secondary channel comprising:
determining that a frame has been received on the secondary channel; and,
relaying the frame to an intended wireless node on the secondary channel.

2. The method of claim 1, wherein the intended wireless node is an access point.

3. The method of claim 1, wherein the intended wireless node supports multiple in, multiple out transmissions.

4. The method of claim 1, wherein the frame is transmitted using a signal and the relay comprises:
amplifying the signal; and
transmitting the signal to the intended wireless node.

5. The method of claim 1, wherein the frame is transmitted using a signal and the relay comprises:
decoding the signal to extract the frame;
performing error correction on the frame; and
transmitting the corrected frame to the intended wireless node.

6. The method of claim 1, further comprising:
entering into an idle mode; and
waking at predetermined intervals from the idle mode.

7. The method of claim 6, wherein the predetermined interval comprises a random interval.

8. The method of claim 1, wherein the determination further comprises detecting a transmission on the secondary channel.

9. An apparatus for wireless communication in a wireless local area network with a primary channel and a secondary channel comprising:
means for determining that a frame has been received on the secondary channel; and,
means for relaying the frame to an intended wireless node on the secondary channel.

10. The apparatus of claim 9, wherein the intended wireless node is an access point.

11. The apparatus of claim 9, wherein the intended wireless node supports multiple in, multiple out transmissions.

12. The apparatus of claim 9, wherein the frame is transmitted using a signal and the relay means comprises:
means for amplifying the signal; and
means for transmitting the signal to the intended wireless node.

13. The apparatus of claim 9, wherein the frame is transmitted using a signal and the relay comprises:
means for decoding the signal to extract the frame;
means for performing error correction on the frame; and
means for transmitting the corrected frame to the intended wireless node.

14. The apparatus of claim 9, further comprising:
means for entering into an idle mode; and
means for waking at predetermined intervals from the idle mode.

15. The apparatus of claim 14, wherein the predetermined interval comprises a random interval.

16. The apparatus of claim 9, wherein the determination means further comprises means for detecting a transmission on the secondary channel.

17. An apparatus for wireless communication in a wireless local area network with a primary channel and a secondary channel comprising:
a receiver for determining that a frame has been received on the secondary channel; and,
a transmitter for relaying the frame to an intended wireless node on the secondary channel.

18. The apparatus of claim 17, wherein the intended wireless node is an access point.

19. The apparatus of claim 17, wherein the intended wireless node supports multiple in, multiple out transmissions.

20. The apparatus of claim 17, wherein the frame is transmitted using a signal and the transmitter comprises:
an amplifier for amplifying the signal; and
an antenna for transmitting the signal to the intended wireless node.

21. The apparatus of claim 17, wherein the frame is transmitted using a signal, further comprising a processor configured to:
decode the signal to extract the frame;
perform error correction on the frame; and
transmit the corrected frame to the intended wireless node.

22. The apparatus of claim 17, further comprising a processor configured to:
enter into an idle mode; and
wake at predetermined intervals from the idle mode.

23. The apparatus of claim 22, wherein the predetermined interval comprises a random interval.

24. The apparatus of claim 17, wherein the receiver is further configured to detect a transmission on the secondary channel.

25. An apparatus of wireless communication in a wireless local area network with a primary channel and a secondary channel comprising:
a memory storing frames received on the secondary channel; and,
a processing system configured to:
determine that a frame has been received on the secondary channel; and
relay the frame to an intended wireless node on the secondary channel.

26. The apparatus of claim 25, wherein the intended wireless node is an access point.

27. The apparatus of claim 25, wherein the intended wireless node supports multiple in, multiple out transmissions.

28. The apparatus of claim 25, wherein the frame is transmitted using a signal and the processing system is further configured to:
amplify the signal; and
transmit the signal to the intended wireless node.

29. The apparatus of claim 25, wherein the frame is transmitted using a signal and the processing system is further configured to:
decode the signal to extract the frame;
perform error correction on the frame; and
transmit the corrected frame to the intended wireless node.

30. The apparatus of claim 25, wherein the processing system is further configured to:
enter into an idle mode; and
wake at predetermined intervals from the idle mode.

31. The apparatus of claim 30, wherein the predetermined interval comprises a random interval.

32. The apparatus of claim 25, wherein the processing system is further configured to detect a transmission on the secondary channel.

33. A computer-program product for facilitating wireless communication in a wireless local area network with a primary channel and a secondary channel, comprising:
a machine-readable medium encoded with instructions executable by a processor to cause the processor to:
determine that a frame has been received on the secondary channel; and,
relay the frame to an intended wireless node on the secondary channel.

34. An apparatus, comprising:
a transceiver for wireless communication in a wireless local area network with a primary channel and a secondary channel; and,
a processing system configured to:
determine that a frame has been received on the secondary channel; and,
relay the frame to an intended wireless node on the secondary channel.

35. A method of wireless communication in a wireless local area network with a primary channel and a secondary channel comprising:
receiving a transmission of a first frame on the primary channel from a first wireless node;
determining that a second frame has been received on the secondary channel from a second wireless node that is relayed from the first wireless node; and,
processing the first frame and the second frame to achieve a MIMO transmission.

36. The method of claim 35, wherein the first frame and the second frame are transmitted on spatially multiplexed channels.

37. The method of claim 35, wherein the determination comprises detecting that the second frame is received within a coherence time of the reception of the first frame.

38. The method of claim 35, wherein the second frame is transmitted using a signal from the first wireless node and the relay comprises:
receiving an amplified signal from the second wireless node; and
processing the amplified signal.

39. The method of claim 35, further comprising:
entering into a monitor mode; and
detecting the transmission on the primary channel.

40. The method of claim 35, wherein the processing comprises combining the first frame and the second frame to achieve MIMO transmit diversity.

41. The method of claim 35, wherein the processing comprises combining the first frame and the second frame to achieve MIMO multiplexing.

42. An apparatus for wireless communication in a wireless local area network with a primary channel and a secondary channel comprising:
means for receiving a transmission of a first frame on the primary channel from a first wireless node;
means for determining that a second frame has been received on the secondary channel from a second wireless node that is relayed from the first wireless node; and,
means for processing the first frame and the second frame to achieve a MIMO transmission.

43. The apparatus of claim 42, wherein the first frame and the second frame are transmitted on spatially multiplexed channels.

44. The apparatus of claim 42, wherein the determination comprises means for detecting that the second frame is received within a coherence time of the reception of the first frame.

45. The apparatus of claim 42, wherein the second frame is transmitted using a signal from the first wireless node and the relay comprises:
means for receiving an amplified signal from the second wireless node; and
means for processing the amplified signal.

46. The apparatus of claim 42, further comprising:
means for entering into a monitor mode; and
means for detecting the transmission on the primary channel.

47. The apparatus of claim 42, wherein the processing means comprises means for combining the first frame and the second frame to achieve MIMO transmit diversity.

48. The apparatus of claim 42, wherein the processing means comprises means for combining the first frame and the second frame to achieve MIMO multiplexing.

49. An apparatus for wireless communication in a wireless local area network with a primary channel and a secondary channel comprising:
a receiver for receiving a transmission of a first frame on the primary channel from a first wireless node;
a processor configured to:
determine that a second frame has been received on the secondary channel from a second wireless node that is relayed from the first wireless node; and
process the first frame and the second frame to achieve a MIMO transmission.

50. The apparatus of claim 49, wherein the first frame and the second frame are transmitted on spatially multiplexed channels.

51. The apparatus of claim 49, wherein the determination comprises means for detecting that the second frame is received within a coherence time of the reception of the first frame.

52. The apparatus of claim 49, wherein the second frame is transmitted using a signal from the first wireless node, further comprising an antenna for receiving an amplified signal from the second wireless node, wherein the processor is further configured to process the amplified signal.

53. The apparatus of claim 49, further comprising:
means for entering into a monitor mode; and
means for detecting the transmission on the primary channel.

54. The apparatus of claim 49, wherein the processing means comprises means for combining the first frame and the second frame to achieve MIMO transmit diversity.

55. The apparatus of claim 49, wherein the processing means comprises means for combining the first frame and the second frame to achieve MIMO multiplexing.

56. An apparatus of wireless communication in a wireless local area network with a primary channel and a secondary channel comprising:
a memory storing a transmission of a first frame on the primary channel from a first wireless node; and
a processing system configured to:
determine that a second frame has been received on the secondary channel from a second wireless node that is relayed from the first wireless node; and
process the first frame and the second frame to achieve a MIMO transmission.

57. The apparatus of claim 56, wherein the first frame and the second frame are transmitted on spatially multiplexed channels.

58. The apparatus of claim 56, wherein the determination comprises means for detecting that the second frame is received within a coherence time of the reception of the first frame.

59. The apparatus of claim 56, wherein the second frame is transmitted using a signal from the first wireless node, further comprising an antenna for receiving an amplified signal from the second wireless node, wherein the processor is further configured to process the amplified signal.

60. A computer-program product for facilitating wireless communication in a wireless local area network with a primary channel and a secondary channel, comprising:
a machine-readable medium encoded with instructions executable by a processor to cause the processor to:
receive a transmission of a first frame on the primary channel from a first wireless node;
determine that a second frame has been received on the secondary channel from a second wireless node that is relayed from the first wireless node; and
relay the first frame and the second frame to achieve a MIMO transmission.

61. An apparatus, comprising:
a transceiver for wireless communication in a wireless local area network with a primary channel and a secondary channel; and,
a processing system configured to:
receive a transmission of a first frame on the primary channel from a first wireless node;
determine that a second frame has been received on the secondary channel from a second wireless node that is relayed from the first wireless node; and
relay the first frame and the second frame to achieve a MIMO transmission.
